(19) United States
(12) Patent Application Publication
(10) Pub. No.: US 2007/0179785 A1
(43) Pub. Date: Aug. 2, 2007

(54) Method for automatic real-time identification of languages in an audio signal and device for carrying out said method

(76) Inventors: Sebastien Herry, Cachan (FR); Celestin Sedogbo, Beynes (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/592,494

(22) PCT Filed: Mar. 1, 2005
(86) PCT No.: PCT/EP05/50869

§ 371 Date: Sep. 12, 2006

(30) Foreign Application Priority Data
Mar. 12, 2004 (FR) 04 02597

(51) Int. Cl. G10L 13/00

(52) U.S. Cl. 704/259

(57) ABSTRACT

The approach of the invention offers a compromise between various problems: number of languages processed, labeling of phonemes, speed. Its principle is acoustic discrimination of languages, which is performed with a neural modeling guaranteeing a low calculation time on execution (for example less than 3 seconds). Furthermore, neural networks generally perform very good discriminations since their prime vocation is to create separator hyper-planes between the various languages taken pairwise. In summary, the invention applies a principle of inter-discrimination of languages, by opposing of language pairs, then by merging the results.

### BACKGROUND OF THE INVENTION

1) Field of the Invention

The present invention pertains to an automatic method of identifying languages, in real time, in an audio signal, as well as to a device for implementing this method.

2) Description of related Art

Automatic devices for identifying languages can be used, for example, in radiophonic stations for listening to transmissions in several different languages so as to direct the transmissions of each language identified towards the specialist in this language or towards the corresponding recording device.

The document “Identifying Language from Raw Speech—An Application of Recurrent Neural Networks” presented at the “5th Midwest Artificial Intelligence and Cognitive Science Conference” in April 1993, pages 53 to 57, describes a device for identifying languages based on neural networks. The device described processes only two languages, in a reduced case of study (a few talkers), and no means is indicated for allowing its possible generalization to several languages and to a large number of talkers. Furthermore, the performance of this device is directly related to the duration of the audio signal (which is 12 s at least).

The main problem with the current systems of automatic language identification (ALI) is that they are based on Acoustico-Phonetic Decoding (APD) which requires a corpus (audio database) labeled at the phonetic level (the phonemes of which have been identified) which is available only in very few languages. It is for this purpose that one sees systems which try to alleviate this lack of corpus by:
reducing the proliferation of language models with the aid of PPRLM (“Parallel Phone recognition followed by Language Modeling”, that is to say audio recognition in parallel followed by the modeling of the language), by using several APDs. But the optimum of this system occurs with as many APDs as languages to be identified. Consequently, this technique of the nongeneralized PPRLM is only a palliative to the lack of APD for the extension of ALI to a large number of languages.
the use of GMMs (“Gaussian Mixture Models”) to replace the APDs.
These two procedures have in common the desire to convert the speech signal into another representation format, so as thereafter to model it.
the use of prosody (detection of the rhythm and of the intonation of speech), to find new acoustic units with the aim of replacing the phonemes and thus create an automatic labeling, but this method is not robust in relation to the possible disturbances of the processed signal and cannot be extended to a large number (several thousand, for example) of different talkers.

The second major problem with the known methods is the calculation time. The more parallel the system is made, the more complex the system becomes, the slower it becomes.

If one seeks a global architecture common to all these language identification systems, one notes that all these systems act in two phases. In a first phase, they seek to detect and to identify acoustic units, generally phonemes or pseudo-phonemes or phonetic macro-classes. Furthermore, usually, these systems carry out a temporal modeling of these phonemes of MMC (Hidden Markov Model) type. The second phase consists in modeling the acoustic unit sequence so as to benefit from phonotactic discrimination (chaining together of the phonemes over time).

### SUMMARY OF THE INVENTION

The present invention is aimed at an automatic method of identifying languages which can operate in real time, and whose implementation is the simplest possible. Its subject is also a device for implementing such a method.

The method in accordance with the invention is an automatic method of identifying languages in real time in an audio signal, according to which the audio signal is digitized, the acoustic characteristics are extracted therefrom and it is processed with the aid of neural networks, and it is characterized in that each language to be processed is detected by discrimination between at least one pair of languages comprising the language to be processed and another language forming part of a corpus of samples of several different languages and that for each language processed, all the samples of the incident signal are temporally merged over a finite duration, doing so for all the possible pairs comprising each time the processed language considered and one of the other languages taken into account.

According to a characteristic of the invention, the temporal merging is carried out by calculating over a finite duration the average value of all the samples whose modulus exceeds a determined threshold. According to another characteristic of the invention, the average value of the results of the first merging is calculated and this average value is compared with another determined threshold

The approach of the invention offers a compromise between various problems: number of languages processed, labeling of phonemes, speed. Its principle is acoustic discrimination of languages, which is performed with a neural modeling guaranteeing a low calculation time on execution (for example less than 3 seconds). Furthermore, neural networks generally perform very good discriminations since their prime vocation is to create separator hyper-planes between the various languages taken pairwise. In summary, the invention applies a principle of inter-discrimination of languages, by opposing of language pairs, then by merging the results.

### BRIEF DESCRIPTION OF THE DRAWINGS

The present invention will be better understood on reading the detailed description of an embodiment, taken by way of nonlimiting example and illustrated by the appended drawing, in which:

FIG. 1 is a simplified diagram of the various steps of the method of the invention,

FIG. 2 is a diagram of distance rejection curves in English versus French identification in the training phase of the method of the invention,

FIG. 3 is a diagram of distance rejection curves in English versus French identification in the test phase of the method of the invention,

FIG. 4 is a block-diagram of an exemplary embodiment of an English language detector in accordance with the invention,

FIG. 5 is a diagram of distance rejection curves at the identification of English output in the test phase of the method of the invention,

FIG. 6 is a diagram making explicit the phase of refinement of the decision during the detection of a language, and

FIG. 7 is a diagram of rejection curves of difference type at the outputs of the English language detection reinforcement network.

### DETAILED DESCRIPTION OF THE INVENTION

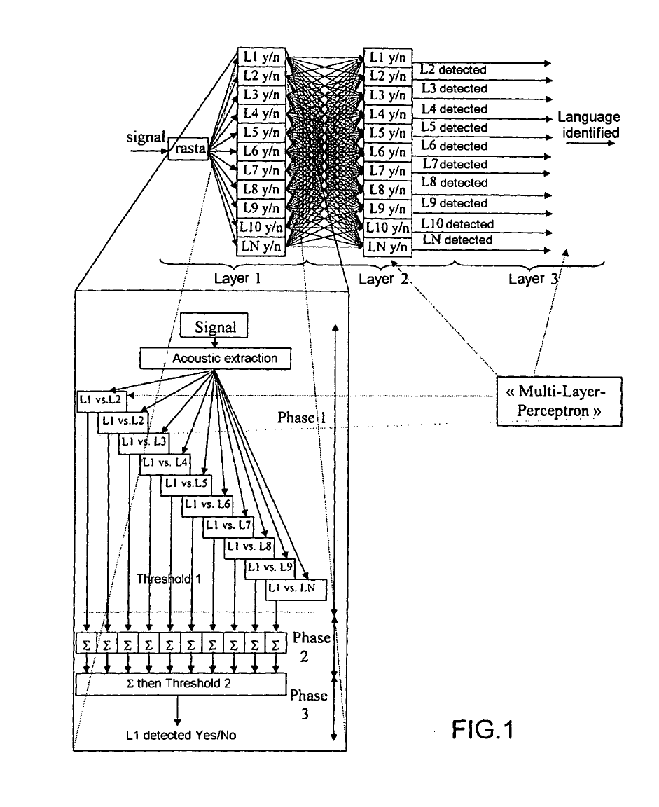

The diagram of FIG. 1 illustrates in a global manner a device implementing the various steps of the method of the invention. The languages to be recognized are numbered from L1 to LN. In the present example, eleven different languages (N=11) are processed, but it is of course understood that the invention can apply to an arbitrary number of languages, and at the minimum two languages, but it is generally preferable that N be the largest possible (having regard to the linguistic database available). In this diagram, layer 1 is composed of N systems for detecting languages with neural networks (denoted “L1 y/n” to “LN y/n”), at a rate of one per language. Each detection system uses N-1 discriminating systems. To simplify the drawing, the lower part of FIG. 1 represents only the details of embodiment of the discriminating system relevant to the detection system “L1 y/n”. The discriminating system represented in detail comprises N-1 elementary discriminators denoted “L1 vs L2” to “L1 vs LN”. Each of these elementary discriminators comprises two outputs on which respectively appear an item of information regarding distance of membership in the language considered (language L1 for the example of FIG. 1) and an item of information regarding distance of membership in the other language used for the elementary discrimination (other language denoted L2 to LN respectively for the discriminators “L1 vs L2” to “L1 vs LN”). The information appearing on these various outputs is thereafter compared individually with a first threshold S1, then they are “merged” temporally and globally, for example by individually calculating the temporal average (function denoted “Phase 2”) of the output information of each elementary discriminator for all the incident samples arising consecutively during a finite time span (in the present case, for which one wishes to identify a language as rapidly as possible, this time span is 3 seconds, and the samples have a duration of 32 ms, with a mutual coverage of 16 ms, but it is of course understood that these parameters can have other values, as a function of the applications envisaged). The various average values thus obtained are “merged” globally, for example by calculation of their global average value, and compared with a second threshold S2 (function denoted “phase 3”). The value of the mismatch with respect to S2 constitutes the output information of the detection system “L1 y/n” and represents the information regarding detection or non-detection of L1. These operations are performed in the same way for all the other detection systems “L2 y/n” to “LN y/n”. The thresholds S1 and S2 are determined experimentally during the training of the neural networks of the system so as to obtain the best possible recognition results.

Each discriminating system detects on the one hand the language that it is in charge of and on the other hand one of the other languages. The results of each of these discriminating systems are merged over time. Then the outputs of the discriminating systems are merged, thus creating the detection output of the language considered.

Layer 2 is composed of N systems for reinforcing the language detection decision. These systems make it possible to take into account the modelings of the other languages.

Layer 3 makes it possible to pass from a technique of language detection to a technique of language identification by a classification of the various detections.

This system is implemented in two main steps. The first consists in teaching the discriminating systems (training of their neural networks) then in adjusting the global system with various thresholds. The second step is actual use, where the samples of the incident signal are made to traverse a path going from layer 1 to layer 3.

The discriminating systems “L1 vs Li” (i going from 1 to N for the detection system “L1 y/n”, and so on and so forth for the other detection systems) are taught using acoustic vectors, while the identification is done using phrases of a greater duration (3 s) involving an accumulation of the results over time and making it possible to refine the response.

To effect the training of the discriminating systems, it is necessary to organize the starting corpus. To embody the system, it is necessary to have available a multilingual speech corpus. Conclusive trials have been conducted with the shortest possible size of data, i.e. 3 s. To do this, a transformation of the corpus is necessary. All the audio files of the corpus are sliced into files of 3 s, then classed by categories: man, woman, child, non-native, then again in each of these categories, another level of category is created as a function of the language examined, and inside them, three sub-categories are created: training, “trial” (corpus part used for validation, during discrimination between the languages taken pairwise), and test, at a rate of ⅗, ⅕, ⅕ of the samples of the corpus in each sub-category.

From this new corpus, the following are extracted for each of the languages: a training base arising from the “training” sub-categories but without distinction as to sex, age, or native language. Likewise for the trial base and test base. These bases are translated with the aid of a speech coder (acoustic extractor of RASTA type with 23 parameters, the power coefficient having been removed). Using sliding windows of 32 ms interleaved by 16 ms, each of the audio files of 3 s is transformed into a sequence of RASTA parameter vectors. The concatenation of these sequences makes it possible to constitute new bases (so-called prime RASTA bases).

The implementation of the discriminating systems of the invention is performed by the discrimination of one language with respect to another. This implementation is done by each of the elements referenced “L1 vs LN” in the diagram of FIG. 1. For this purpose, the creation of databases is necessary for training and testing. Specifically, the modeling used is of neural type, since the invention uses neural networks with the aim of creating a hyper-plane separating the languages pairwise, as well as a distance of membership in a class, a class being one of the two languages.

We proceed in the following manner for the creation of the training (APP), trial (ESS), and test (TST) databases. These bases are created from the prime RASTA bases of each of the languages, keeping the separation APP, ESS, TST. They comprise the same number of examples for each class. The samples are drawn randomly from the base. A sample (a RASTA parameter vector) corresponds to 32 ms of audio segment. A base consists in equal shares of each of the classes, the samples being alternated.

Thereafter the training is undertaken in the following manner. The neural network used in the present case is of the MLP (multi layer perceptron) type and its dimensions are for example: 23 inputs, 50 neurons in the hidden layer and 2 output cells (one per class). The training proceeds in the following manner: the examples of each of the classes are presented alternately, one class then the other and so on and so forth, the classes being in this instance English and French. The training stepsize is fixed. The modification of the weights of the neural networks is done after each sample, and all the samples are presented in the same order, in an iterative manner. We use the trial base to stop the training and thus avoid over-training.

Two types of sample rejections are used in the classification phase. The first is called distance and is calculated in the following manner:

consider two variables x1 and x2 (characterizing the estimated degree of membership in one and in the other language of the sample examined) varying between −1 and +1, and R (threshold of rejection) varying likewise from −1 to +1.

for each sample:

If x1 is greater than R and x1 is greater than x2, then x1 wins

If x2 is greater than R and x2 is greater than x1, then x2 wins

If neither of these cases holds, the sample is rejected.

The second type of rejection is called difference and is calculated in the following manner:

consider two variables x1 and x2 varying between −1 and +1, and R (threshold of rejection), likewise varying, but from 0 to +2.

If the absolute value of x1 minus x2 is less than or equal to R, we reject.

Otherwise the larger value between x1 and x2 triumphs.

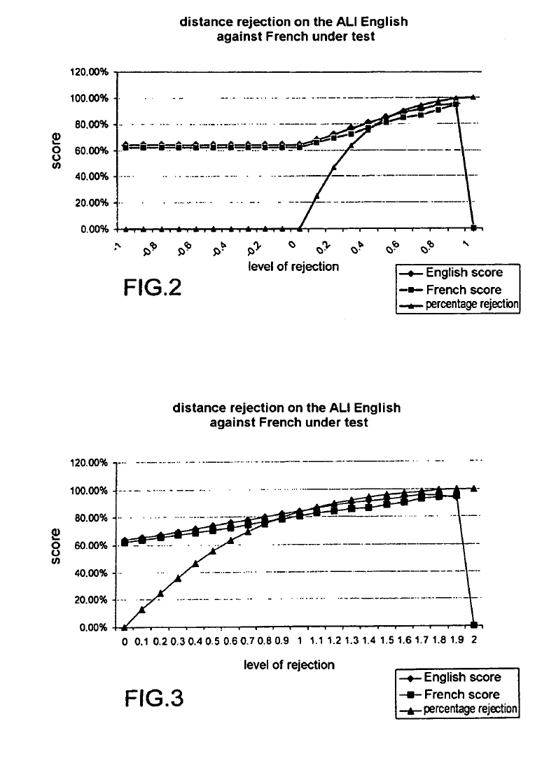

The results obtained are those of the “English versus French” discrimination with the two types of rejections, on the test base (training corpus APP), during evaluation. The examples are drawn randomly from the base, whatever the class. The curves obtained are represented in FIGS. 2 and 3. These curves show that the recognition scores without rejection are 62% on average and that rejection makes it possible to improve these results. Note that the rejection has a fast growth. The scores are established on the principle: number of correct responses given per class with respect to the total number of nonrejected samples of the class. This makes it possible to deduce that the information regarding “amplitude” of the output level of the cells has a significance which would (statistically speaking) be a level of certainty. These scores have been obtained with samples (produced by RASTA acoustic extraction) each representing the equivalent of 32 ms of audio file.

The invention furthermore comprises the generalization of the discrimination to the other possible language pairs (L1 vs L2 to L1 vs LN), namely (English; Persian), (English; German), (English; Hindi), (English; Japanese), (English; Korean), (English; Mandarin), (English; Spanish), (English, Tamil), (English; Vietnamese). In the same manner, for these pairs, the three types of bases APP, ESS, TST are constructed and in the same manner as previously the neural networks of like dimensions are taught. The results are presented in the table below.

The scores appearing in the table below correspond to the percentages of the diagonal of the confusion matrix, the first column corresponding to the language pair (English; Persian), the second to the pair (English; French), and so on and so forth.

The scores of the first row correspond to the ratio of the number of times that the corresponding network has responded English while actually English was submitted to it, to the total number of English examples which have been submitted to it.

The scores of the second row correspond to the ratio of the number of times where the network has responded “other language”, namely, in each case, respectively Persian, French, etc. while actually the sample submitted corresponded to this “other language”, to the total number of examples of this “other language”.

The third row corresponds to the average of the previous two.

| | Persian | French | German | Hindi | Japanese | Korean | Mandarin | Spanish | Tamil | Vietnamese |
|---|---|---|---|---|---|---|---|---|---|---|
| actual language | 59.87% | 63.82% | 61.50% | 60.85% | 60.13% | 61.17% | 65.43% | 65.40% | 64.03% | 63.92% |
| other language | 63.84% | 62.25% | 59.03% | 67.70% | 65.49% | 67.52% | 63.23% | 57.40% | 65.24% | 66.81% |
| total | 61.86% | 63.04% | 60.27% | 64.28% | 62.81% | 64.35% | 64.33% | 61.40% | 64.64% | 65.37% |

The global average is 63.23%. The rejection has the same effects as previously. It is therefore possible to increase these scores by increasing the number of samples for a decision taking, by passing from 32 ms (equivalent to a snatch of phoneme) to a phrase. The results are discriminations between English and another language, the aim being to succeed in obtaining an English yes/no output.

The following step of the method of the invention consists in passing from the discrimination “one language versus another” to the information “language detected or not detected”.

This step is implemented by reusing the neural networks previously created to perform this task. But the networks have been taught to recognize two languages, therefore a merging of the robust information is required, both over time and for the whole set of various networks.

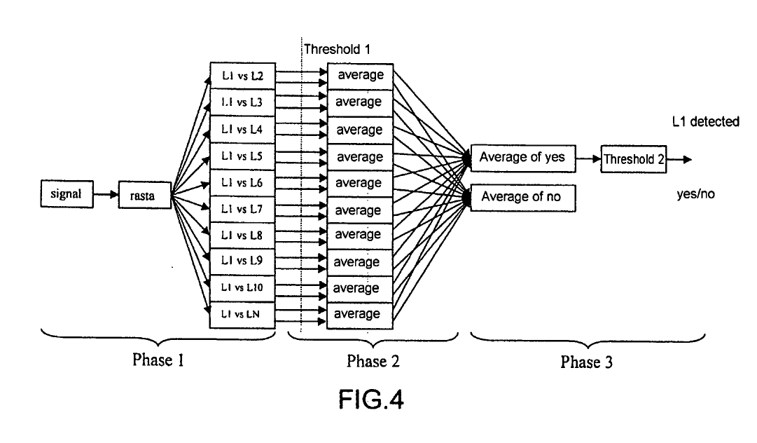

The passage from the acoustic parameter vectors (RASTA) to the phrases of 3 s has been done through a temporal average of the outputs of the various networks. These two averages are obtained with the aid of the detector represented in FIG. 4 (which borrows the elements of the lower part of FIG. 1), this detector corresponding in the diagram of FIG. 1 to an element dubbed “Li y/n” (i being able to take one of the values from 1 to N).

During phase 1, the RASTA coding extracts the acoustic parameters from the raw signal. These parameters are thereafter submitted to each of the ten networks (“L1 vs L2” to “L1 vs LN”). The incident acoustic signal lasts 3 s, the coding (RASTA) produces a sequence of parameters, and the networks produce for these 3 s on each of their outputs a sequence of information.

During phase 2, the sequence produced by each of the networks is recovered and the average is computed individually, and each network produces a pair of two parameters.

During phase 3, the sum of the various parameters is computed, those appearing at the “yes” output corresponding to English and the “no” outputs to the other language.

Note in FIG. 4 that there exist two thresholds, Threshold 1 and Threshold 2. Threshold 1 is a level which comes into the average operation and is determined with a “difference rejection” criterion, and it makes it possible to calculate the average only over the values having an absolute difference which is greater than it. Threshold 2, is used as decision threshold, on the basis of the “average of yes” information. It would be possible to use as a supplement the “average of no” information, although it is not used in the present example.

These two thresholds have been determined by performing tests on a large number of combinations of these two thresholds (for example several hundred), retaining those which gave rise to the best scores at output on the APP corpus.

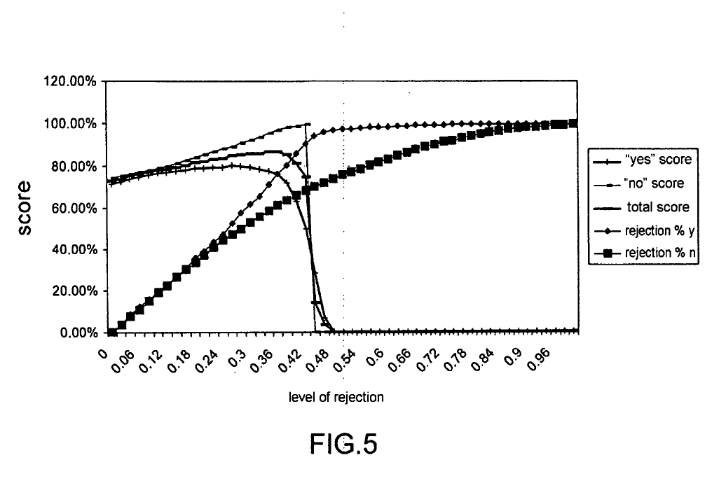

According to another characteristic of the invention, when the samples whose distance (or, possibly difference), such as defined above, is such that neither x1 nor x2 triumphs are rejected, it is possible to improve the recognition scores. Specifically, considering for example the output “English identified” of the diagram as a continuous value, and replacing the “yes/no” by the mismatch measured between the average and Threshold 2, and applying said distance rejection to this output information, the curve of FIG. 5 is obtained. The legends of FIG. 5 are as follows:

level of rejection: distance rejection varying from 0 to 1,

“yes” score: ratio of the number of times where English is recognized to the total number of English examples employed,

“no” score: ratio of the number of times where non-English is recognized to the total number of non-English examples employed,

total score: average of “yes” scores and of “no” scores,

rejection % y: ratio of number of English elements rejected to the total number of English elements,

rejection % n: ratio of the number of non-English elements rejected to the total number of non-English elements.

Again note that the amplitude of the response has a sense, that without rejection English is identified at 73%, on the test corpus. Note furthermore that for 30% of rejection, English is identified at 80%.

| | English | Persian | French | German | Hindi | Japanese | Korean | Mandarin | Spanish | Tamil | Vietnamese |
|---|---|---|---|---|---|---|---|---|---|---|---|
| actual language | 71.64% | 66.60% | 76.48% | 71.02% | 71.00% | 70.02% | 69.76% | 70.91% | 71.07% | 79.71% | 72.76% |
| other language | 74.61% | 69.02% | 75.83% | 71.75% | 72.67% | 72.21% | 75.26% | 73.71% | 74.29% | 79.61% | 77.17% |
| total | 73.13% | 67.81% | 76.15% | 71.38% | 71.84% | 71.11% | 72.51% | 72.31% | 72.68% | 79.66% | 74.97% |

As shown diagrammatically in FIG. 1, the device of the invention is applied to the other languages (L2 to L11) of the corpus. For this purpose the training, trial and test corpuses are created for all the language pairs. The corpus used at the outset is the well-known corpus named OGI (“Oregon Graduate Multilingual Speech Corpus”), which has available ten other languages. The corresponding ten training, trial and test bases are created for each of them. The neural networks (phase 1 of FIG. 4) are taught using these bases following the same operative mode as for English. The same discrimination structure is created for the passage to the phrases of 3 s, and the corresponding thresholds are determined using the same procedure as for English. This generalization of the system has made it possible to arrive at the results presented in the table below:

This table summarizes the scores of the various systems for detecting languages. These scores are calculated on the principle: number of correct detections of a class with respect to the total number of examples of the class, the first class being the language to be detected and the second comprising all the other languages. These results are obtained without rejection, the curves with rejection (not represented) being the same shape for each of the detection systems. The global average of the detectors is 73%, for audio segments of 3 s. This average of 73% shows that the generalization has been conclusive and that the procedure is reproducible. Furthermore, note that each discriminator gives its response independently of the others, and the amplitudes of the output information of these discriminators have a sense that is deduced from the rejection curves. It is possible also to utilize the output information of the other discriminators with the aim of reinforcing the decision of a discriminator.

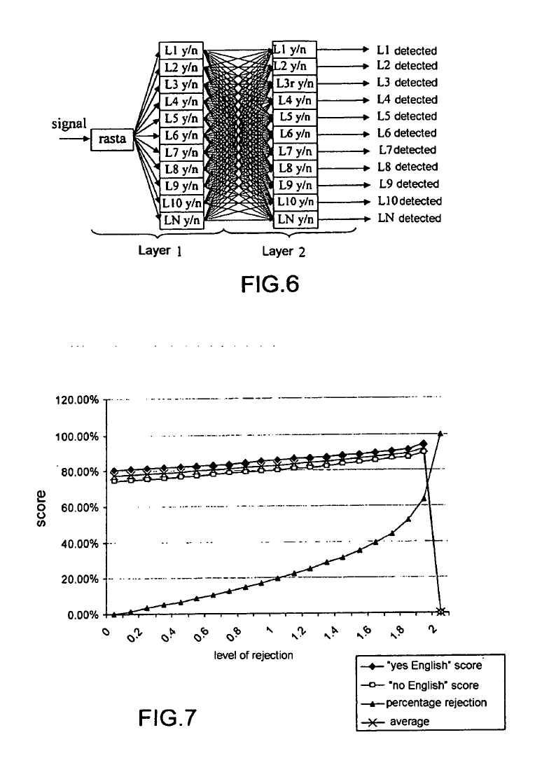

According to another characteristic of the invention, the reinforcing of the decision taking is aimed at using the knowledge afforded by the other language detection outputs to refine the actual response of a discriminator of a given language. This refinement is carried out by the addition of an extra layer at the output of the language detectors, as shown by FIG. 6.

The second layer consists of eleven distinct neural networks of MLP (“Multi Layer Perceptron”) type. All these networks have identical dimensions, which are, for the present example: 11 inputs, 22 neurons in the hidden layer and 2 output cells, the first cell corresponding to the: “yes it is the language”, and the second to the: “no it is not the language”.

The training is done in the same manner as for the networks of the first layer, with a training and trial base. The examples are presented alternatively by class, the modification of the weights of the networks is done after the passage of each sample, and the training stepsize is constant. The creation of the training, trial and test bases is done in the following manner: during phase 1, the “prime” training, trial and test bases (corresponding to the RASTA parameters) are transformed. For each language detector, three output databases are thus created corresponding to the bases APP, ESS and TST. The output information of each detector is the distance between the value of the “average of the yes” and the “threshold 2” (detection diagram for English). The merging of the outputs of the detectors creates the new training, trial and test bases (denoted respectively APP2, ESS2, TST2), for the second layer. Each reinforcing network possesses its inherent bases which are extracted from the newly created bases (APP2, ESS2, TST2), in the sense where the classes of each of these reinforcing networks are different. For example, for English: class 1 is English and class 2 is the merging of the other ten languages: Persian, French, German . . . For Vietnamese: class 1 is Vietnamese and class 2 is the merging of the other ten languages: English, Persian, French, German . . .

With the aim of keeping a statistical equilibrium, an identical number of samples is taken randomly, but in a homogeneous manner in each of the languages, doing so for the training, trial and test bases. Class 1 is duplicated ten times and the samples disposed alternately in the other classes.

Thus, a reinforcing network possesses three bases: training, trial, and test, which are extracted respectively from APP2, ESS2, and TST2.

The results in a test of the trainings of the various networks are presented in the table below:

| | yes score | no score | total score |
|---|---|---|---|
| English | 78.45% | 77.29% | 77.87% |
| Persian | 73.91% | 76.36% | 75.14% |
| French | 79.31% | 78.90% | 79.11% |
| German | 76.53% | 76.02% | 76.28% |
| Hindi | 77.99% | 76.44% | 77.22% |
| Japanese | 74.09% | 78.80% | 76.45% |
| Korean | 76.41% | 75.45% | 75.93% |
| Mandarin | 74.27% | 77.72% | 76.00% |
| Spanish | 76.90% | 78.47% | 77.69% |
| Tamil | 85.10% | 80.11% | 82.61% |
| Vietnamese | 77.22% | 78.61% | 77.92% |
| | | average | 77.47% |

The “yes score” column corresponds to the ratio of the number of times that the network has responded “yes this is my language” to the total number of samples of the language to be identified. The “no score” column corresponds to the number of times that the network has responded “no it is not the language” to the total number of samples that are not the language to be identified. Biases, corresponding to the addition of a slight quantity on the outputs of the networks, are introduced so as to reduce the difference between the columns: “yes score” and “no score” of the above table. These biases are determined experimentally using the results of the trial base of the network. These results are without rejection. They make it possible to obtain a gain of more than 4 points for the language detection.

If a difference type rejection is performed on the outputs of the network identifying English, the results illustrated by the curves of FIG. 7 are obtained. These curves are obtained without the bias “balancing” the scores without rejection, (the bias in fact deforms the rejection curves). These curves show that if 20% of the processed samples are rejected, more than 5 points of correct detection are gained and at 40% rejections, we go to 10 points of increase. Thus with 40% of rejection we go from 77% detection to 87%. These curves are reproduced for the detections of the other languages.

Furthermore, note that the amplitude of the output still has a sense. It is therefore possible to extract information on the amplitude, in terms of certainty as to the decision, since the larger the response, the more the identification rate increases.

With the aim of seeing what errors were made, a confusion matrix for the detection of languages has been established. This matrix makes it possible to ascertain the results by language. This matrix is presented below:

| | English | Persian | French | German | Hindi | Japanese | Korean | Mandarin | Spanish | Tamil | Vietnamese |
|---|---|---|---|---|---|---|---|---|---|---|---|
| English | 78.91% | [symbol] .64% | 25.41% | 23.39% | 21. [symbol] 3% | 21.27% | 22.65% | 22. [symbol] 5% | 24.77% | 21.55% | 21.73% |
| Persian | 22.14% | 74.05% | 26.34% | 27.67% | 25.38% | 21.95% | 29.20% | 17.75% | 21.18% | 17.56% | 27.86% |
| French | [symbol] .92% | 22.84% | 79.02% | 32.33% | 14.38% | 25.21% | 28.60% | 19.63% | 20.81% | 13.87% | 15.06% |
| German | 24.12% | 27.97% | 30.65% | 76.55% | 27.81% | 21.61% | 32.66% | 24.96% | 22.28% | 19.26% | 18.43% |
| Hindi | 17. [symbol] 6% | 34.76% | 17.13% | 26.53% | 77.10% | 20.59% | [symbol] 1.42% | 24.88% | 21.42% | 24.05% | 23.72% |
| Japanese | 20. [symbol] % | 19.27% | 19.70% | 20.77% | 24.63% | 74.52% | 24.84% | 29.34% | 25.27% | 15.63% | 20.99% |
| Korean | 22.38% | 20.71% | 25.48% | 32.6 [symbol] % | 17.38% | 21.67% | 75.48% | [symbol] 8.57% | 16.19% | 16.43% | 20.95% |
| Mandarin | 23.31% | 23.12% | 16.57% | 23.70% | 25.43% | 23.70% | 23.89% | 73.22% | 18.63% | 19.85% | 29.67% |
| Spanish | 32.75% | 20.99% | 24.80% | 21.30% | 25.91% | 23.37% | 17.97% | 19.55% | 75.68% | 26.23% | 20.35% |
| Tamil | 20.66% | 15.17% | 10.42% | 17.55% | 21.94% | 14.81% | 20.48% | 14.26% | 23.22% | 85.37% | 19.20% |
| Vietnamese | 19.68% | 27.44% | 12.92% | 14.31% | 24.25% | 14.51% | 22.47% | 26.64% | 17.30% | 21.67% | 75.84% |
| yes score | 78.91% | 74.05% | 79.02% | 76.55% | 77.10% | 74.52% | 75.48% | 73. [symbol] % | 75.68% | 85.37% | 75.94% |
| no score | 75.68% | 76.35% | 78.57% | 76.07% | 77.14% | 79.01% | 75.77% | 78.14% | 78.45% | [symbol] 0.01% | 78. [symbol] % |
| total | 77.8 [symbol] % | 75.20% | 78. [symbol] 0% | 76.31% | 77.12% | 76.7 [symbol] % | 75.62% | 75. [symbol] 8% | 77.06% | 82.69% | 77.13% |
| average | 77. [symbol] 9% | | | | | | | | | | |

Each box of the matrix corresponds to the ratio of the detections over the total number of the audio segments of 3 s submitted. The rows correspond to the language actually submitted and the columns to the results of the various detectors. Thus, note that when English is submitted to the English detector, the latter identifies English at 78.91%. But note also that the Persian detector confuses Persian and English at 22.84%. The “yes score” row corresponds to the score of correct detection by the appropriate detector. The “no score” row corresponds to the average of the scores of correct non-detection of the appropriate detector. The “total” row corresponds to the average of the detection and non-detection scores. And the “average” box corresponds to the global average of the detectors.

This global average makes it possible to show that the eleven languages of the OGI corpus are detected with a score of 77.29% on phrases of 3 s.

To go from the detection of languages to the identification of a language in the incident signal presented to the input of the device of the invention, it is necessary to go via a classification (with the aid of the “classifier” of FIG. 1), transforming the “yes/no” of the detections into the choice of one of the languages present in the modeling or, as appropriate, if unknown languages of the modeling are submitted and if we want the system to reject them, we add an “unknown language” output to the classifier. The classifier can likewise be neural or rule-based.

In the normal regime of use, the incident audio signal passes through the whole system and there is no need for any training. When this signal traverses the various networks, the averages are calculated and the results are thresheld, then the classifier allowing the identification of the language present in this incident signal is used.

1. An automatic method of identifying languages in real time in an audio signal, which is digitized and the acoustic characteristics are extracted therefrom and the acoustic characteristics are processed with the aid of neural networks, comprising the steps of: detecting each language to be processed by discriminating between at least one pair of languages including the language to be processed and another language forming part of a corpus of samples of several different languages and for each language processed temporally merging, all the samples of the audio signal over a finite duration, and temporally merging all the possible pairs each time including the processed language considered and one of the other languages taken into account.

2. The method as claimed in claim 1, wherein the temporal merging is carried out by calculating over a finite duration the average value of all the samples whose modulus exceeds a determined threshold.

3. The method as claimed in claim 1, wherein the average value of the results of the first merging is calculated and this average value is compared with another determined threshold.

4. The method as claimed in claim 1, wherein said finite duration is 3 seconds.

5. The method as claimed in claim 1, wherein the corpus is used for the training of the neural networks, for trials and for tests.
